(19) United States
(12) Patent Application Publication
(10) Pub. No.: US 2017/0262355 A1
(43) Pub. Date: Sep. 14, 2017

(54) DEBUGGING APPLICATIONS

(71) Applicant: International Business Machines Corporation, Armonk, NY (US)

(72) Inventors: Ying Liu, Beijing (CN); Yan Shi, Beijing (CN); Xiu Lei Zhu, Beijing (CN); Jia Zou, Beijing (CN)

(21) Appl. No.: 15/063,827

(22) Filed: Mar. 8, 2016

(51) Int. Cl. G06F 11/36

(52) U.S. Cl. CPC G06F 11/362

(57) ABSTRACT

A method, executed by a computer, for debugging a cloud application includes establishing an HTTP connection with a remote server, sending an HTTP request with a request for state information for a program executing on the remote server, and receiving, from a cloud container, state information in an HTTP response. A computer program product and computer system corresponding to the above method are also disclosed herein.

### BACKGROUND OF THE INVENTION

The present invention relates generally to debugging applications, and in particular, debugging Java applications.

In the field of cloud applications, users may often find the need to debug a cloud application on a remote resource. Remotely debugging Java applications requires that the debugger and debuggee communicate via Java Debug Wire Protocol. However, using Java Debug Wire Protocol may necessitate a lag between each debugging step, resulting in seconds or even minutes elapsing before the next step may be transmitted. Thus, there is a need for a faster means of remotely debugging Java cloud applications.

### SUMMARY

As disclosed herein, a method, executed by a computer, for debugging a cloud application includes establishing an HTTP connection with a remote server, sending an HTTP request with a request for state information for a program executing on the remote server, and receiving, from a cloud container, state information in an HTTP response. A computer program product and computer system corresponding to the above method are also disclosed herein.

### BRIEF DESCRIPTION OF THE DRAWINGS

FIG. 1 is a block diagram depicting one embodiment of an debugging system in accordance with the present invention;

FIG. 2 is a flow chart depicting one embodiment of a requesting method in accordance with the present invention;

FIG. 3 is a flow chart depicting one embodiment of a responding method in accordance with the present invention;

FIG. 4 is a flow chart depicting operational steps of debugging a cloud application in accordance with one embodiment of the present invention;

FIG. 5 is a flow chart depicting operational steps of debugging a cloud application in accordance with one embodiment of the present invention;

FIG. 6 is a flow chart depicting one embodiment of a debugging method in accordance with the present invention;

FIG. 7 is a block diagram depicting one example of a computing apparatus (i.e., computer) suitable for executing the methods disclosed herein;

FIG. 8 depicts a cloud computing environment according to an embodiment of the present invention; and

FIG. 9 depicts abstraction model layers according to an embodiment of the present invention.

### DETAILED DESCRIPTION

Embodiments of the present invention relate generally to debugging cloud applications more specifically, to debugging Java applications on the cloud by using HTTP requests. Ordinarily, a Java Debug Interface may be used to debug a remote server hosting a Java Virtual Machine Tool Interface, with the two communicating via Java Debug Wire Protocol. However, each debug step may be sent separately over TCP socket, leading to a lag of seconds or minutes between transmission of steps. Embodiments of the present invention seek to hasten the debugging process by attaching debugging requests and responses as query parameters to HTTP requests and responses. Thus, Java cloud applications may be remotely debugged over a persistent HTTP connection. Furthermore, embodiments of the present invention enable debugging of cloud applications that are only available on a cloud platform, and/or debugging of cloud applications that already have context in the cloud.

It should be noted that references throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following drawings, description and appended claims, or may be learned by the practice of the invention as set forth hereinafter. The present invention will now be described in detail with reference to the FIGURES.

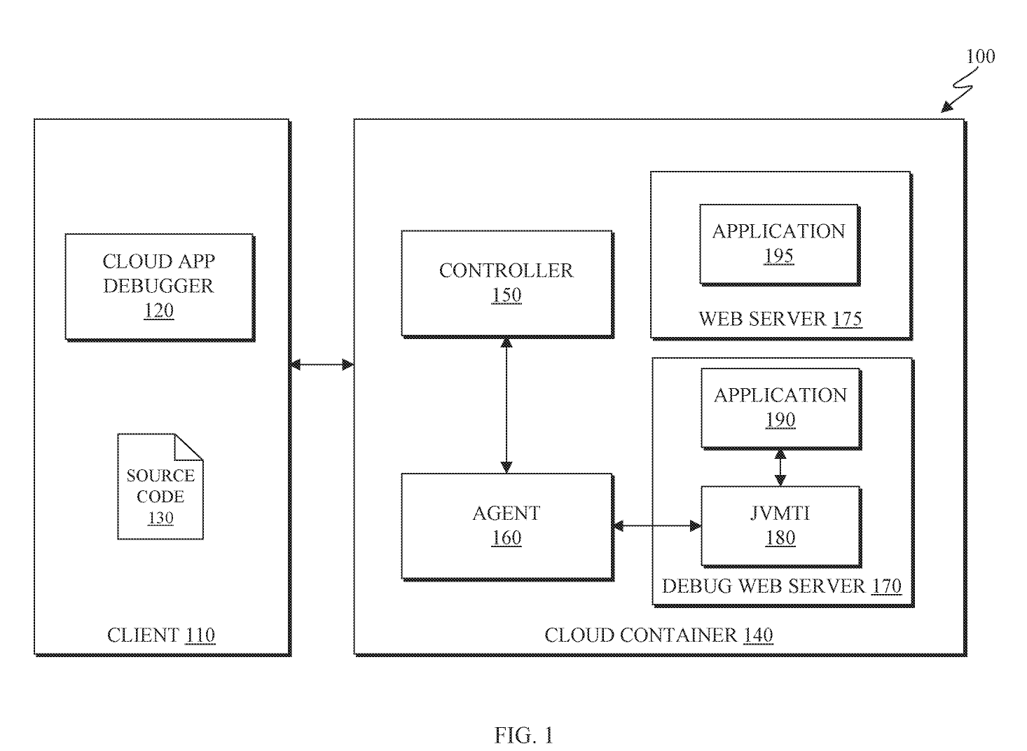

FIG. 1 is a block diagram depicting one embodiment of a debugging system 100 in accordance with the present invention. As depicted, debugging system 100 may include a client 110, cloud application debugger 120, source code 130, cloud container 140, controller 150, agent 160, deb web server 170, web server 175, Java virtual machine tool interface 180, application 190, and application 195. The client 110 and cloud container 140 may communicate via a network such as an intranet or the Internet. In some embodiments, when debug mode is disabled, then cloud container 140 does not have debug web server 170, Java virtual machine tool interface 180, and/or application 190, whereas when debug mode is enabled all of these elements are present.

The client 110 may include a cloud application debugger 120 and source code 130. The client 110 may be used to remotely access and debug the cloud container 140. In some embodiments, the client 110 is a web browser and the cloud application debugger 120 is a browser plug-in. In some embodiments, client 110 is an Eclipse browser and cloud application debugger 120 is an Eclipse plug-in The client 110 may re-use an already-existing HTTP connection with the cloud container 140 in order to facilitate debugging of Java applications (e.g. the application 190) running on cloud container 140. The client 110 may attach a debug parameter to an HTTP request automatically, which then initiate debug mode on the server end.

The cloud application debugger 120 may debug by attaching debug info, such as a query parameter, to an HTTP request, which is then sent to the cloud container 140 via an already-existing HTTP connection. The cloud application debugger 120 may receive debug information that is attached to an HTTP response. Source code 130 may be the source code for application 190. Thus, the cloud application debugger 120 may debug the remote application 190 by re-creating its execution using source code 130 and the debug information received from cloud container 140 as input.

Cloud container 140 may include controller 150, agent 160, web server 170, debug web server 175, Java virtual machine tool interface (JVMTI) 180, application 190, and application 195. Cloud container 140 may host one or more web servers 175 running one or more Java applications 195. In some embodiments, client 110 sends an HTTP request containing debug parameters to cloud container 140. The HTTP request may be received by controller 150. If the HTTP request indicates a request to initiate debugging, controller 150 may launch debug web server 170, which is a server in debug mode. Debug web server 170 may run alongside web server 175 such that service is uninterrupted during the debugging process (e.g., debugging debug web server 170 does not affect web server 175 in any meaningful way).

Agent 160 may receive debug information from controller 150. In some embodiments, agent 160 parses the HTTP debug parameters in order to separate and identify the debug request information, which it then parses into discrete debugging actions. Agent 160 may communicate with JVMTI 180 in order to operate on the application 190 as would a local debugger (despite cloud application debugger 120 being remote from cloud container 140). In some embodiments, agent 160 and JVMTI 180 communicate by Java Debug Wire Protocol (JDWP).

Cloud container 140 may host one or more servers such as web server 175. Web server 175 may be any information technology that processes requests via HTTP, the basic network protocol used to distribute information on the World Wide Web. In some embodiments, the web server 170 to be debugged is launched by controller 150 in a special debug mode; the original web server 175 may continue to function paralle to debug-enabled web server 175 so that there is no lapse in service.

Java virtual machine tool interface (JVMTI) 180 may operate on application 190 as it would during traditional Java debugging. Application 190 may include any sort of Java cloud application. In some embodiments, JVMTI 180 passes along parsed instructions from agent 160 such as the lines at which debugging will start/stop, as well as which variables are to be tracked. JVMTI 180 may receive from application 190 state information, which is the value of one or more variables at a given line of the program's execution. JVMTI 180 may operate on application 190 by monitoring the activity and results of debugging on application 190.

Server 175 and application 195 may not be subject to debugging. In some embodiments, server 175 and application 195 are running at the time of instantiation of debug web server 170 and application 190, and server 175 and application 195 continue executing in order to provide uninterrupted service to the end user. Thus, when debug mode is disabled, debug web server 170 and application 190 may not appear as elements of debugging system 100.

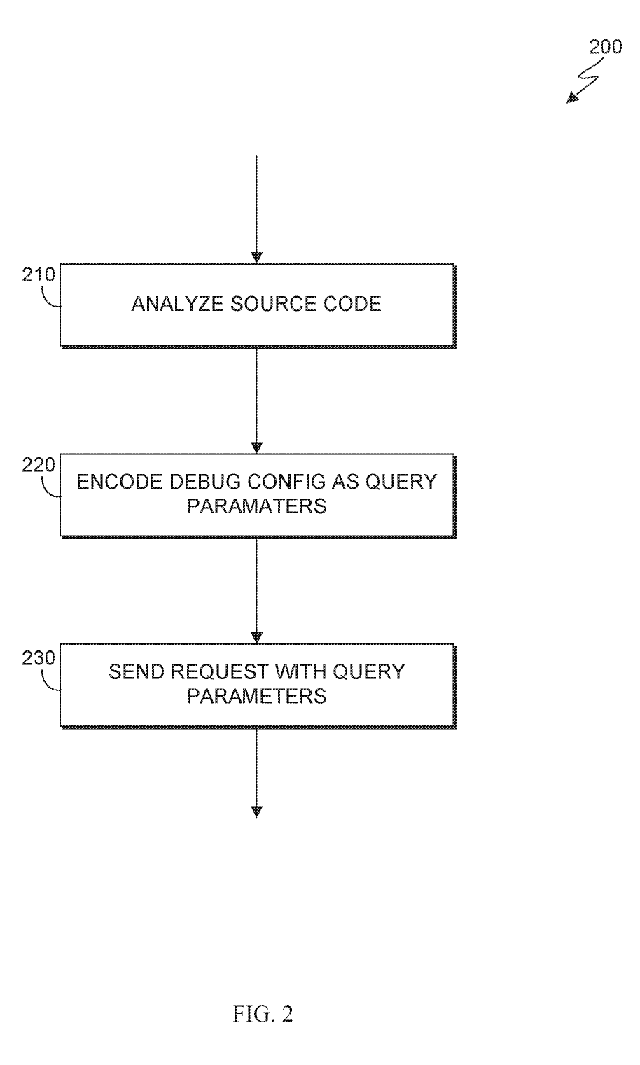

FIG. 2 is a flow chart depicting one embodiment of a requesting method 200 in accordance with the present invention. As depicted, the requesting method 200 includes analyzing (210) source code, encoding (220) debug configuration as query parameters, and sending (230) a request with query parameters. The requesting method 200 is used to attach a request for state information onto an HTTP request.

Analyzing (210) source code may include analyzing source code 130 in order to determine which state information should be requested in the HTTP request. Specifically, the state information that is requested may include the values of one or more variables at specific lines in the source code.

Encoding (220) debug configuration as query parameters may include attaching a request for state information onto the HTTP request. In some embodiments, the request for state information is rendered as query parameters that are concatenated onto the HTTP request. For example, a normal HTTP request may be:
http://example.org:port/path/
   If, for example, the state information for classfile c1 lines 10 to lines 50 and variables a and b, the state information may be rendered as query parameter:
debug=true&classfile=c1&linefrom=10&lineto=50&vars=a-b
   which may be appended to the HTTP query to result in a state request being included as query parameters, resulting in an HTTP request such as:
http://example.org:port/path/?debug=true&classfile=c1&linefrom=10&lineto=50&vars=a-b

Sending (230) a request with query parameters may include sending an HTTP request with query parameter appended to cloud container 140. In some embodiments, the request is sent over a TCP socket and the HTTP connection is persistent. The HTTP request may be sent via HTTPS protocol.

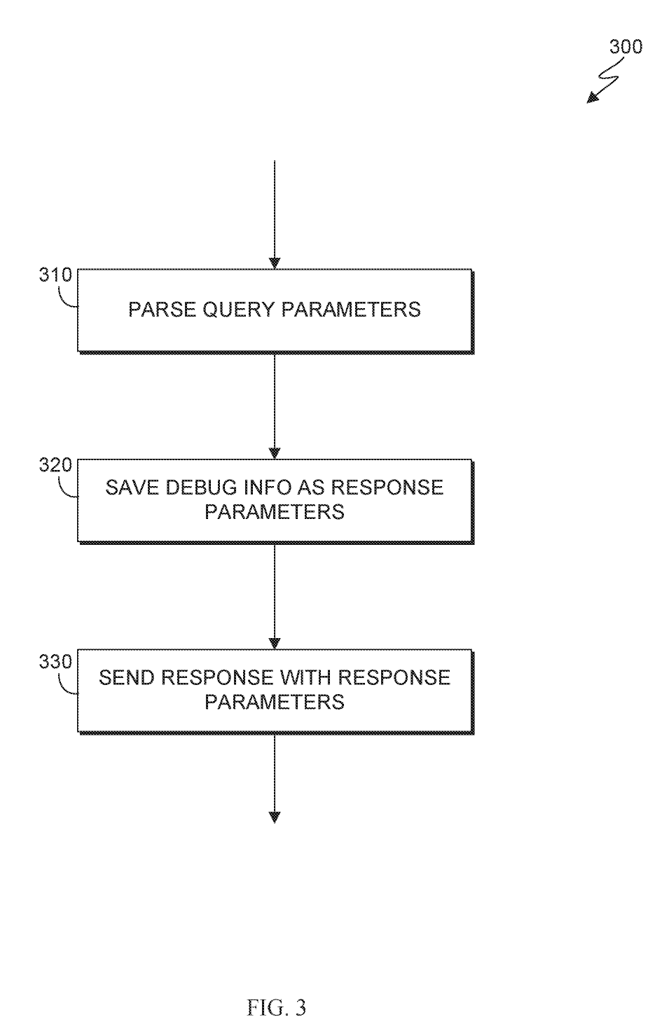

FIG. 3 is a flow chart depicting one embodiment of a responding method 300 in accordance with the present invention. As depicted, responding method 300 includes parsing (310) query parameters, saving (320) debug information as response parameters, and sending (330) a response with the response parameters. The responding method 300 generates a response to the request of requesting method 200.

Parsing (310) query parameters may include parsing the query parameters attached to the HTTP request that was received into a request for state information. Such details that may be parsed from the query parameters are class file information and the state information for variables across lines of code. Once parsed, the request for state information may be used to debug the servlet, resulting in corresponding debug information.

Saving (320) debug information as response parameters may include encoding the debug information (which contains responses to the state information request) as parameters to be added onto an HTTP response. In some embodiments, the JVMTI 180 generates the debug information and passes it to controller 150. Sending (330) a response with the response parameters may include generating an HTTP response with debug information attached. In some embodiments, the HTTP response is sent from controller 150 to cloud application debugger 120.

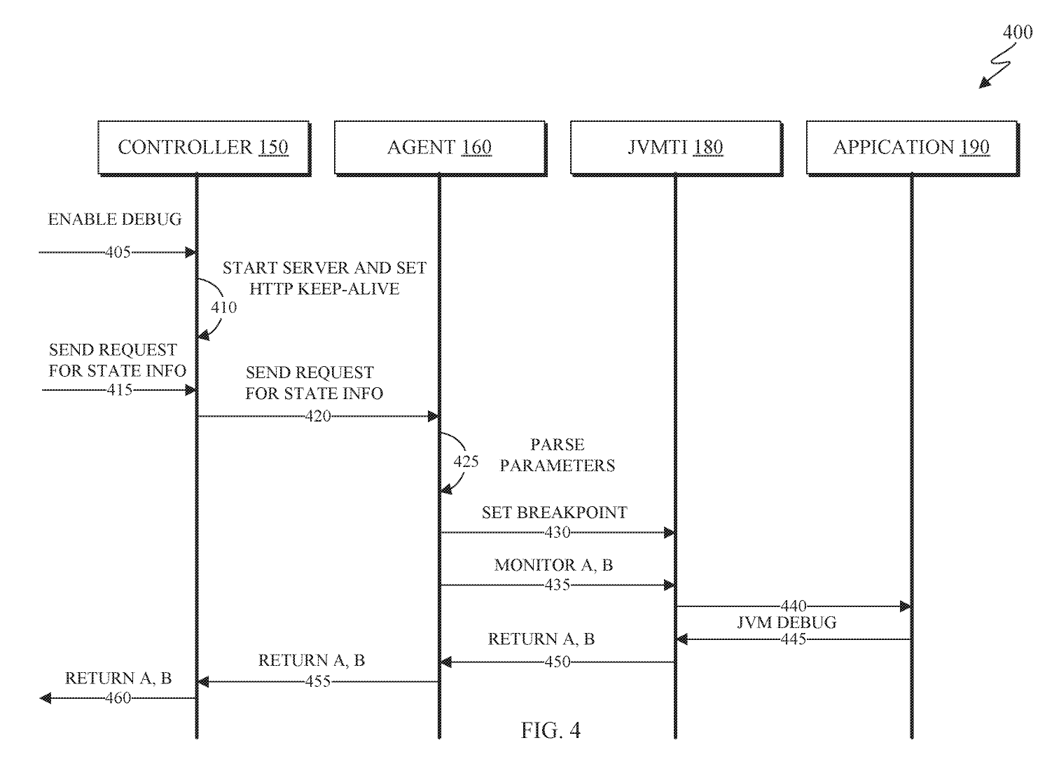

FIG. 4 is a flow chart depicting operational steps 400 of debugging a cloud application in accordance with one embodiment of the present invention. As depicted, the operational steps 400 include enabling (405) debug mode, starting (410) the server, sending (415-420) a request for state information, parsing (425) parameters, setting (430) a breakpoint, monitoring (435) variables a and b, debugging (440-445), and returning (450-460) values for a and b. The operational steps 400 may occur on cloud container 140 between controller 150, agent 160, JVMTI 180, and application 190.

Enabling (405) debug may include send a request to controller 150 for debugging Java application 190. In some embodiments, the debugging request is parameterized onto the HTTP request as “debug=true”. Once controller 150 receives the enable debug operational step 405, controller may start (410) a server in debug mode and set HTTP to keep-alive. Starting (410) the web server 170 may result in a new web server 170 being instantiated in debug mode, so that service is uninterrupted.

Sending (415) a request for state information may include sending a request for state information encoded as parameters onto an HTTP request. Once the controller 150 receives the request for state information, the request is passed along to agent 160 via operational step 420. Agent 160 parses the parameters of the request at operational step 425. In some embodiments, the parsed parameters contain instructions to set a breakpoint at a certain line, to set single-step mode, and to monitor certain variables. Single-step mode may indicate that debugging is to proceed by incrementing the debugging process through one line of code at a time, from the start line to stop line. In the depicted example, the operational step of set breakpoint 430 indicates to JVMTI 180 to start at a particular line, such as line 10. The operational step of monitor a, b 435 may instruct JVMTI 180 to monitor the state information of certain variables, such as a and b in the depicted example.

Debugging (440-445) the Java virtual machine may include JVMTI 180 discovering state information for the requested variables. The state information for a and b may then be returned to agent 160 (via operational step 450), which passes it to controller 150 (via operational step 455), which finally returns the state information for a and b to client 110 (via operational step 460).

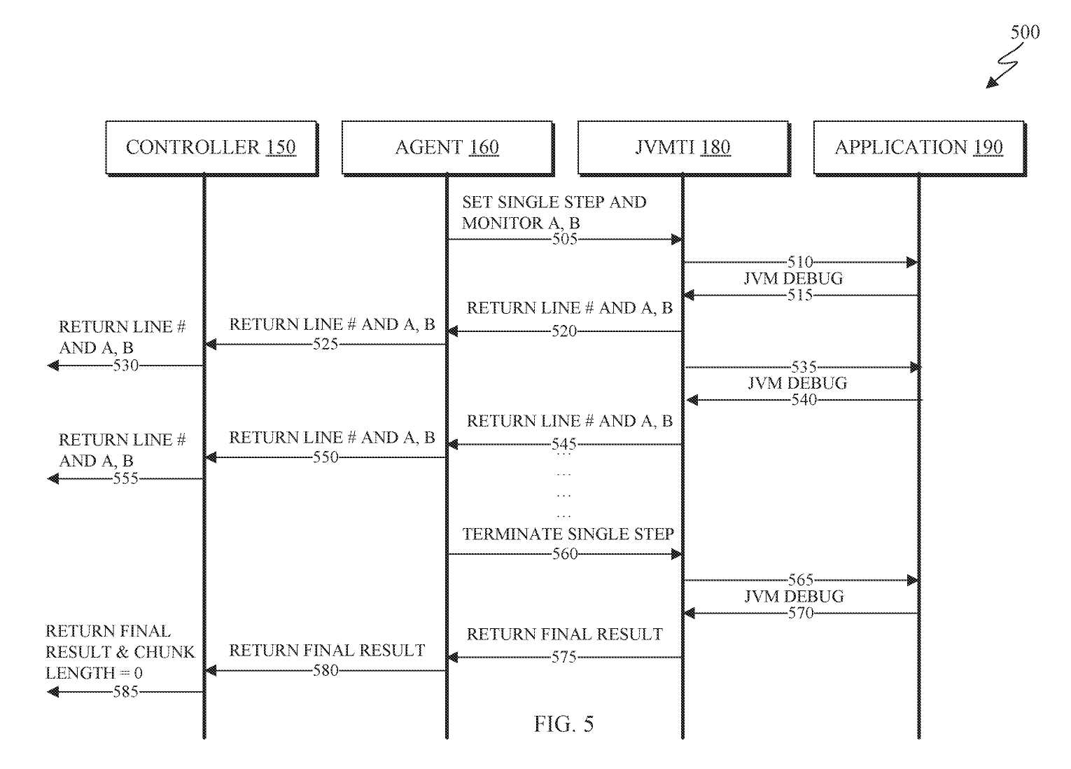

FIG. 5 is a flow chart depicting operational steps 500 of debugging a cloud application in accordance with one embodiment of the present invention As depicted, the operational steps 500 include setting (505) single-step mode and monitoring a and b, debugging (510-515) and returning (520-530) state information, debugging (535-545) and returning (545-555) state information again, terminating (560) the single-step monitoring of variables, debugging (565) a final time, and returning (575-585) the final results. In some embodiments, the operational steps 500 begin after operational step 425 in the operational steps 400 of FIG. 4.

Setting (505) single-step monitoring of variables may include agent 160 instructing JVMTI 180 to begin the stepwise debugging of application 190 by requesting state information for specified variables, such as a and b. JVMTI 180 debugs application 190 via operational steps 510-515 and returns the state information via operational steps 520-530. Debugging may then increase a step, debug (steps 535-540), and return the state information again via operational steps 545-555. This process may repeat until terminating (560) the single step debugging upon reaching the end line, which may result in a final debug operation (steps 565-570) and returning the final results (575-585). In some embodiments, returning (585) the final results also includes setting the chunk length equal to zero. A chunk length equal to zero may indicate that it is the end of the response body.

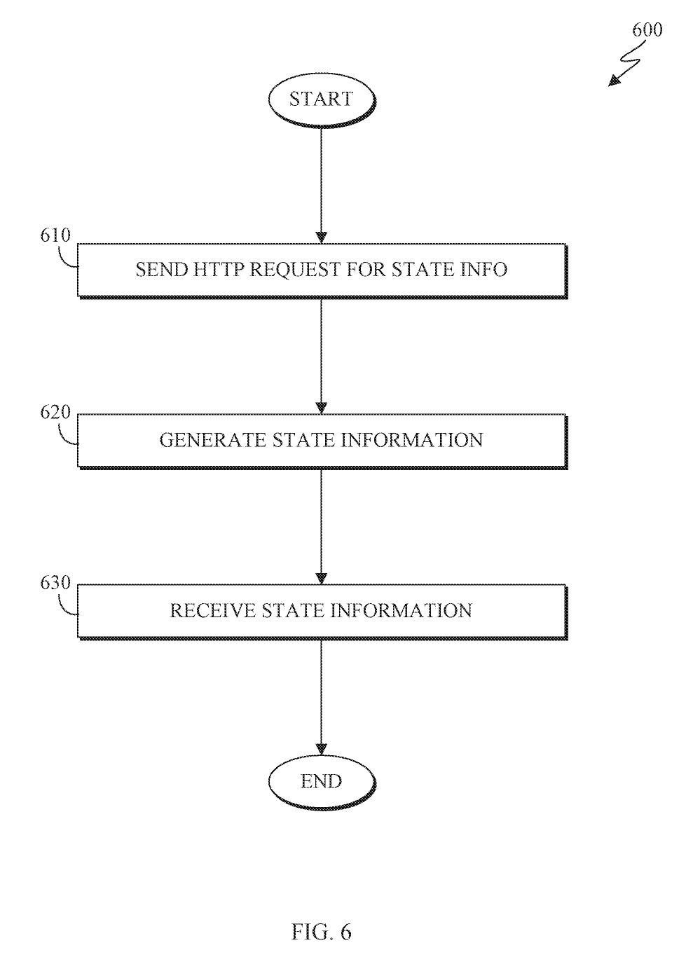

FIG. 6 is a flow chart depicting one embodiment of a debugging method 600 in accordance with the present invention. As depicted, debugging method 600 includes sending (610) an HTTP request, generating (620) state information, and receiving (630) state information. The debugging method 600 may enable a user to debug a remote Java application over an existing HTTP connection.

Sending (610) the HTTP request for state information may include sending an HTTP request to cloud container 140 containing parameters that encode a request for state information. The HTTP request may be sent over an existing HTTP connection. In some embodiments, the existing HTTP connection is a connection between debugger and host of debugee. In some embodiments, debugger is cloud application debugger 120 and debuggee is application 190 hosted on cloud container 140. State information may include a request for the values of one or more variables at specified lines of code. In some embodiments, the client 110 and/or cloud application debugger 120 encode the state information as parameters that are concatenated onto an HTTP request.

Generating (620) state information may include generating a response containing the requested state information. In some embodiments, the state information generation operation 620 may be performed via operational steps 400 and/or operational steps 500. The state information may then be encoded as parameters that are included in an HTTP response.

Receiving (630) state information may include responding to the HTTP request with an HTTP response that contains the state information that was requested. In some embodiments, the client 110 or cloud application debugger 120 receives the state information from controller 150 or cloud container 140. The state information may be used by cloud application debugger 120 to debug locally on client 110 by simulating execution of application 190 using the state information and source code 130.

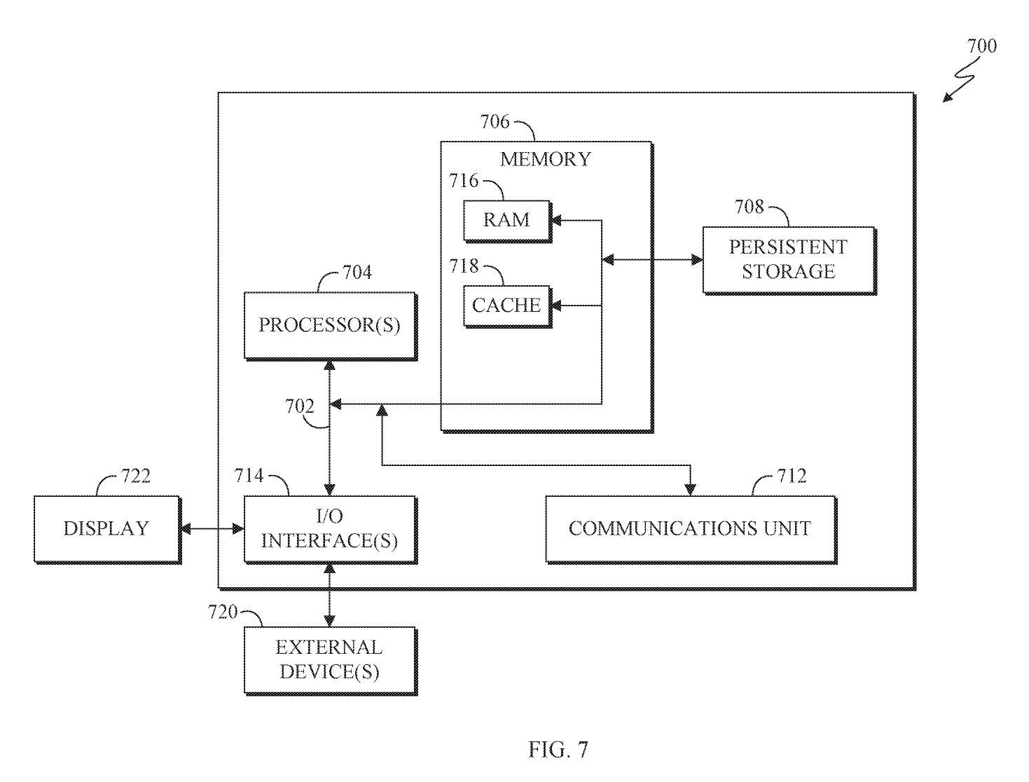

FIG. 7 is a block diagram depicting components of a computer 700 suitable for executing the methods disclosed herein. It should be appreciated that FIG. 7 provides only an illustration of one embodiment and does not imply any limitations with regard to the environments in which different embodiments may be implemented. Many modifications to the depicted environment may be made.

As depicted, the computer 700 includes communications fabric 702, which provides communications between computer processor(s) 704, memory 706, persistent storage 708, communications unit 712, and input/output (I/O) interface(s) 714. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 706 and persistent storage 708 are computer readable storage media. In the depicted embodiment, memory 706 includes random access memory (RAM) 716 and cache memory 718. In general, memory 706 can include any suitable volatile or non-volatile computer readable storage media.

One or more programs may be stored in persistent storage 708 for execution by one or more of the respective computer processors 704 via one or more memories of memory 706. The persistent storage 708 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer readable storage medium that is also part of persistent storage 708.

Communications unit 712, in these examples, provides for communications with other data processing systems or devices. In these examples, communications unit 712 includes one or more network interface cards. Communications unit 712 may provide communications through the use of either or both physical and wireless communications links.

I/O interface(s) 714 allows for input and output of data with other devices that may be connected to computer 700. For example, I/O interface 714 may provide a connection to external devices 720 such as a keyboard, keypad, a touch screen, and/or some other suitable input device. External devices 720 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 708 via I/O interface(s) 714. I/O interface(s) 714 may also connect to a display 722. Display 722 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The embodiments disclosed herein include a system, a method, and/or a computer program product. The computer program product may include a computer readable storage medium (or media) having computer readable program instructions thereon for causing a processor to carry out the methods disclosed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the FIGURES illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

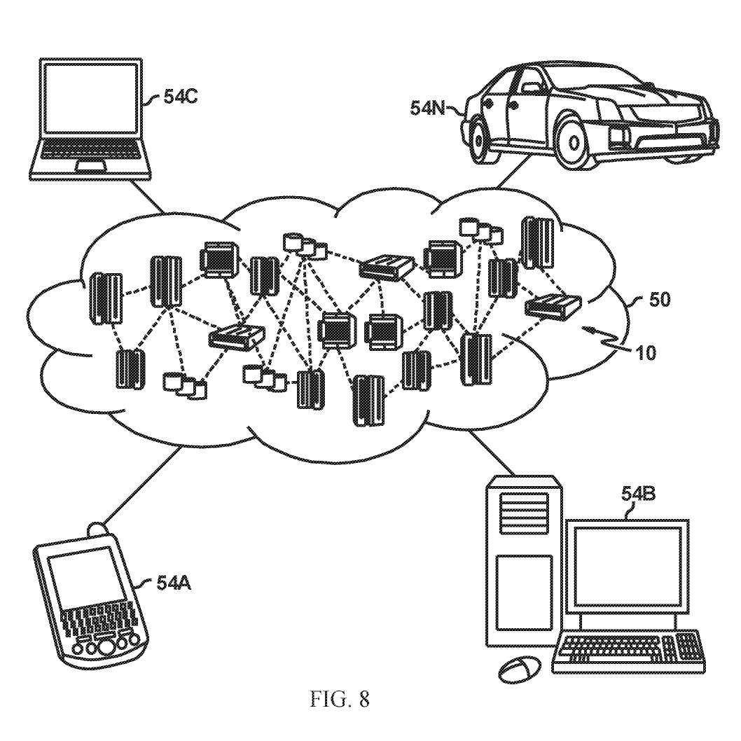

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

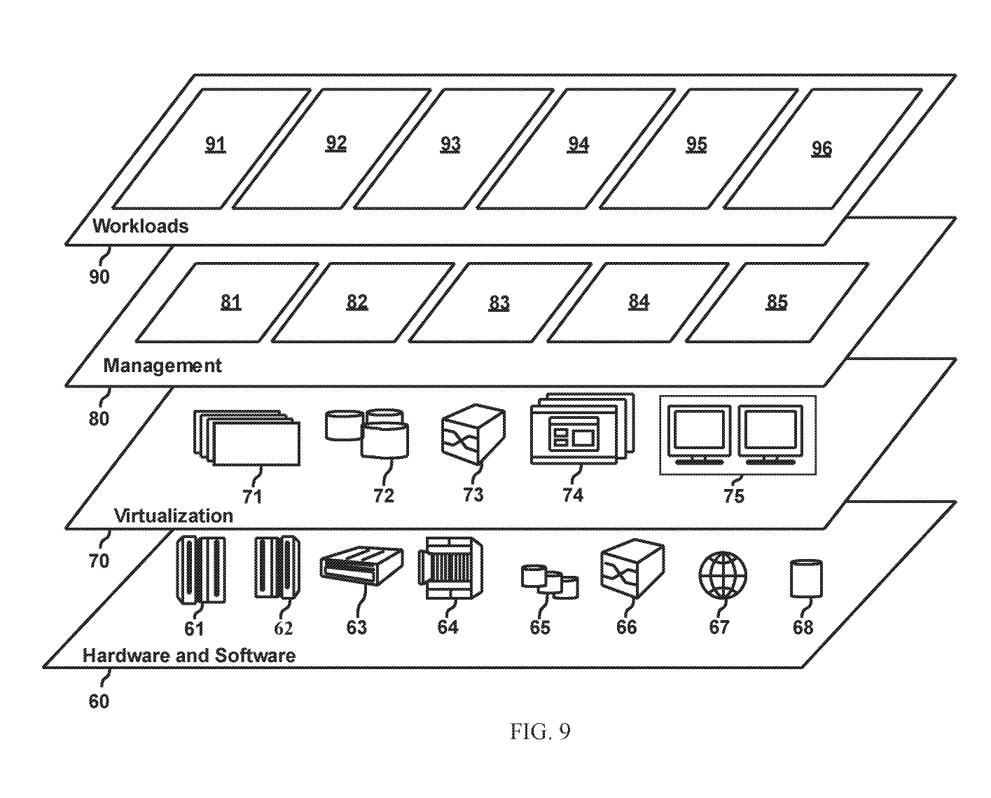

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cloud container 96.

What is claimed:

1. A method for debugging an application, the method comprising:
attaching a request for state information for a program executing on a remote server to an HTTP request, wherein the HTTP request is sent over an already-existing HTTP connection between a container and the remote server;
sending the HTTP request with the attached request for state information to the container and
receiving, from the container, state information attached to an HTTP response provided in response to the HTTP request, wherein the HTTP response is sent over the existing HTTP connection.

2. The method of claim 1, wherein the request for state information comprises a request for a value of a variable at a specific line number in the program.

3. The method of claim 1, wherein the state information requested from the container comprises a value of a variable at a specific line number in the program.

4. The method of claim 1, wherein the container comprises a controller, an agent, a Java virtual machine tool interface, and the program.

5. The method of claim 4, wherein the request for state information is interpreted by the agent.

6. The method of claim 4, wherein the Java virtual machine tool interface generates the state information included in the HTTP response.

7. The method of claim 4, wherein receiving, from a container, state information in an HTTP response enables a user to debug the program.

8. A computer system for debugging an application, the computer system comprising:
one or more computer processors;
one or more computer readable storage media; program instructions stored therein for execution by at least one of the one or more computer processors, the program instructions comprising instructions for:
attaching a request for state information for a program executing on a remote server to an HTTP request, wherein the HTTP request is sent over an already-existing HTTP connection between a container and the remote server;
sending the HTTP request with the attached request for state information to the container and
receiving, from the container, state information attached to an HTTP response provided in response to the HTTP request, wherein the HTTP response is sent over the existing HTTP connection.

9. The computer system of claim 8, wherein the request for state information comprises a request for a value of a variable at a specific line number in the program.

10. The computer system of claim 8, wherein the state information requested from the container comprises a value of a variable at a specific line number in the program.

11. The computer system of claim 8, wherein the container comprises a controller, an agent, a Java virtual machine tool interface, and the program.

12. The computer system of claim 11, wherein the request for state information is interpreted by the agent.

13. The computer system of claim 11, wherein the Java virtual machine tool interface generates the state information included in the HTTP response.

14. The computer system of claim 11, wherein instructions for receiving, from a container, state information in an HTTP response enable a user to debug the program.

15. A computer program product for debugging an application, the computer program product comprising:
a computer readable storage medium and program instructions stored on the computer readable storage medium, the program instructions comprising instructions for:
attaching a request for state information for a program executing on a remote server to an HTTP request, wherein the HTTP request is sent over an already-existing HTTP connection between a container and the remote server;
sending the HTTP request with the attached request for state information to the container and
receiving, from the container, state information attached to an HTTP response provided in response to the HTTP request, wherein the HTTP response is sent over the existing HTTP connection.

16. The computer program product of claim 15, wherein the request for state information comprises a request for a value of a variable at a specific line number in the program.

17. The computer program product of claim 15, wherein the state information requested from the container comprises a value of a variable at a specific line number in the program.

18. The computer program product of claim 15, wherein the container comprises a controller, an agent, a Java virtual machine tool interface, and the program.

19. The computer program product of claim 18, wherein the request for state information is interpreted by the agent.

20. The computer program product of claim 18, wherein the Java virtual machine tool interface generates the state information included in the HTTP response.
